(19) United States
(12) Patent Application Publication
(10) Pub. No.: US 2002/0070255 A1
(43) Pub. Date: Jun. 13, 2002

(54) Utility rack for all terrain vehicles

(76) Inventors: Matthew Paul Hebert, Rayne, LA (US); Raymond Phillip Hebert SR., Rayne, LA (US); Raymond Philip Hebert JR., Rayne, LA (US)

Correspondence Address: Ted M. Anthony, Post Office Drawer 3408, Lafayette, LA, 70502, US

(21) Appl. No.: 09/733,265

(22) Filed: Dec. 8, 2000

(51) Int. Cl. B60R 9/00

(52) U.S. Cl. 224/401; 224/526; 224/566

(57) ABSTRACT

Cargo racks for use with all terrain vehicles (“ATV's”) are disclosed. The racks have a generally horizontal base and upwardly extending vertical side walls which, together with the base, form a cargo area. One or more of the upwardly extending vertical side walls are hinged at the base, and can open in an outward direction to form a lift gate. When such a lift gate is in a lowered position, support chains or arms are not required to ensure that the lift gate remains fully extended. When closed, the lift gate is latched in place to prevent inadvertent opening of the lift gate. One or more of the vertical walls, including the lift gate, can be completely removed from the rack as desired.

### CROSS REFERENCES TO RELATED APPLICATIONS

NONE

### STATEMENTS AS TO RIGHTS TO INVENTIONS MADE UNDER FEDERALLY SPONSORED RESEARCH AND DEVELOPMENT

NONE

### BACKGROUND OF THE INVENTION

1. Field of the Invention

The present invention relates to a utility rack for use in connection with all terrain vehicles (“ATV's”), utility vehicles and the like. More particularly, the present invention relates to a utility rack for use in connection with ATV's, utility vehicles and the like, which can be used to carry cargo and other items, and which can be quickly and easily installed on, or removed from, many different models of ATV's. More particularly still, the present invention relates to a utility rack for ATV's and other utility vehicles which provides one or more removable lift gates, as well as means for latching said lift gates in an upright or closed position.

2. Description of the Related Art

Motorized utility vehicles, such as ATV's, are versatile vehicles which can be used for a number of purposes. For example, ATV's are commonly used for hunting, fishing and other outdoor activities. Similarly, ATV's are often used for utilitarian purposes, such as gardening, landscaping and even pulling or pushing light wheeled equipment.

ATV's and other utility vehicles often incorporate carrying racks, bumpers and similar components which can be used for holding and transporting cargo, equipment or the like. Often, these carrying racks are constructed from tubular frames, with wire mesh or panels forming the body of said racks. Alternatively, such carrying racks can be constructed of continuous panels, wherein said panels form the vertical walls and support base of said racks.

Because such carrying racks are typically mounted on or near the upper surface of an ATV, a user is generally required to lift or hoist cargo over the walls of said rack in order to place such cargo within said rack. Accordingly, it is generally beneficial to have means of lowering, retracting or even removing one or more of the upright walls of the rack in order to make loading and/or unloading easier and more efficient. By lowering one or more of the vertical walls of such a rack, a user does not have as far to lift cargo in order to load said cargo into said rack. It is therefore generally beneficial that at least one vertical wall of a cargo rack be hinged or pinned at its base to form a swingable lift gate which can be raised or lowered as desired. However, because ATV's are often used in rugged off-road terrain, and are therefore subject to significant jostling or shaking, even during normal use, it is important that any such lift gates be locked in the desired position. Thus, it is important that such lift gates resist unintended opening or closing. It is also generally beneficial that such lift gates be designed to minimize noisy rattling during use.

In addition to having one or more collapsible lift gates, it is generally beneficial for an ATV utility rack to have one or more vertical walls which can be completely removed from said rack. However, because an ATV is typically subjected to much jostling or shaking during use, it is also important that any such removable walls remain in an upright and latched position, and do not inadvertently or unintentionally become separated from the rest of the utility rack.

The prior art contains references to utility racks, baskets and/or other accessories which can be used in connection with ATV's. Examples of such prior art include: U.S. Pat. No. 6,016,943 to Johnson, et al; U.S. Pat. No. 5,360,259 to Lemberger; U.S. Pat. No. 5,076,387 to Oka; U.S. Pat. No. 4,696,374 to Hale; U.S. Pat. No. 4,300,706 to Hendrick, et al; U.S. Pat. No. 4,247,030 to Amacker; U.S. Pat. No. 4,277,008 to McCleary; and U.S. Pat. No. 4,176,771 to Dubroc. However, none of the cited references disclose the advantages of the present invention. Specifically, none of the cited references disclose a cargo rack which can be quickly and easily attached to an ATV, or removed therefrom, having one or more vertical walls which can be lowered, or removed altogether, to facilitate loading and/or unloading. Furthermore, none of the cited references disclose ATV racks with collapsible or removable walls which can also be latched or locked in an upright position to prevent inadvertent opening or separation from the remainder of the utility rack.

### SUMMARY OF THE INVENTION

The present invention provides a utility rack which can be quickly and easily attached to any number of existing models of ATV's. The utility rack of the present invention can be attached at or near the front or the rear of an ATV. Further, the utility rack of the present invention can also be quickly and easily removed from an ATV.

The utility rack of the present invention provides recessed areas for storing and/or transporting cargo and other equipment on an ATV. These recessed areas are generally comprised of a roughly horizontal base section, as well as upwardly extending vertical side walls which together define a basket-like partial enclosure for holding cargo. The utility rack of the present invention can be positioned at or near the front of an ATV, and can be mounted below the line of sight of the ATV operator. As a result, the utility rack of the present invention mounted at or near the front of an ATV will not impede the ability of an operator to safely and efficiently drive the subject ATV. Similarly, because the utility rack of the present invention mounted at or near the rear of an ATV is designed to be positioned behind the seat of said ATV, said utility rack mounted in this fashion likewise does not affect the safe and efficient operation of the ATV.

In order to facilitate loading and unloading of cargo and/or other equipment from the utility rack of the present invention, one or more vertical side walls of such utility rack can be lowered or collapsed to provide easier access to the recessed basket area of the rack. In the preferred embodiment, such a collapsible vertical side wall is hinged at the base to form a swingable lift gate. Moreover, if desired, one or more of said vertical side walls can be completely removed from said rack. With respect to the front utility rack of the present invention, a vertical side wall which is collapsible to form a lift gate is typically positioned at the forward extent of the ATV. Conversely, with respect to the rear utility rack of the present invention, a vertical side wall which can be lowered to form a lift gate is positioned facing the rear of the ATV. A latch is provided for each of these hinged lift gates so that said lift gates do not become inadvertently lowered or unlatched during use. Further, said latch is spring loaded to prevent rattling or jarring of the lift gate during normal use.

The lift gate of the present invention can also remain in an extended position when lowered without the need for chains or support arms. When opened, the lift gate of the present invention has nothing extending from the vertical side walls to said lift gate, which would limit or otherwise preclude the use of said gate as a horizontal support structure. The absence of such chains or arms greatly improves the versatility of the present invention.

### BRIEF DESCRIPTION OF THE DRAWINGS

FIG. 1 depicts an ATV equipped with the utility racks of the present invention.

FIG. 2a depicts a side elevational view of a front utility rack of the present invention.

FIG. 2b depicts a top perspective view of a front utility rack of the present invention.

FIG. 3a depicts a side elevational view of a rear utility rack of the present invention.

FIG. 3b depicts a top perspective view of a rear utility rack of the present invention.

FIG. 4 depicts a side elevational view of a lift gate of the present invention.

FIG. 5 depicts a side cross-sectional view of a lift gate latch mechanism of the present invention.

### DESCRIPTION OF THE PREFERRED EMBODIMENT(S)

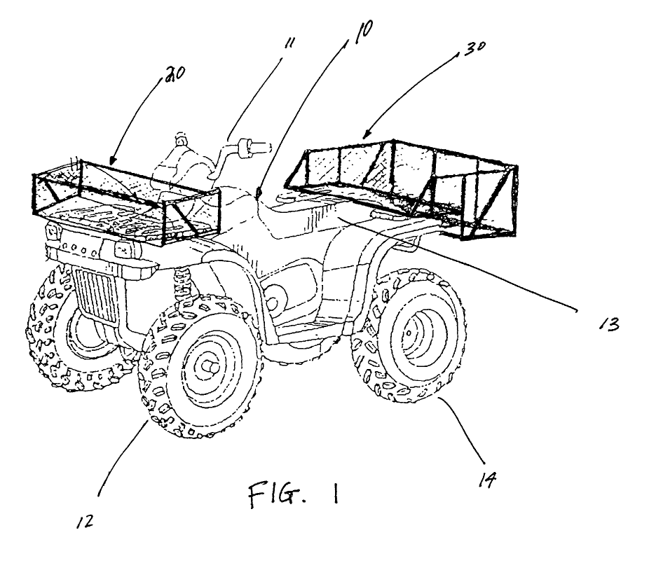

Referring to the drawings, FIG. 1 depicts the utility rack of the present invention mounted on an ATV 10. Front utility rack 20 is positioned at the forward extent of ATV 10, in front of handle bars 11 and generally over front wheels 12. Front utility rack 20 is mounted on ATV 10 such that the upper extent of said utility rack remains at or near the level of handle bars 11 of ATV 10. Accordingly, front utility rack 20 is positioned entirely below the line of sight of an operator of ATV 10 and, therefore, does not present an impediment to the safe and efficient operation of said ATV 10.

Still referring to FIG. 1, rear utility rack 30 is positioned near the rear extent of ATV 10. Rear utility rack 30 is generally mounted behind seat 13 of ATV 10, and generally over rear wheels 14 of ATV 10. Because rear utility rack 30 is mounted behind driver's seat 13 of ATV 10, said rear utility rack likewise does not obstruct the view of a driver, or otherwise present an impediment to the safe operation of ATV 10.

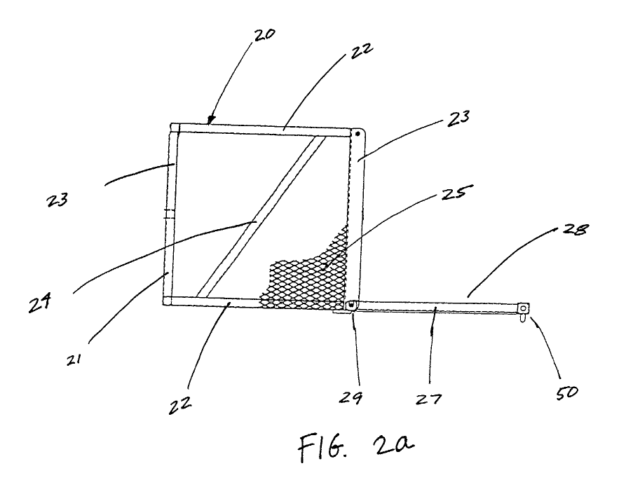

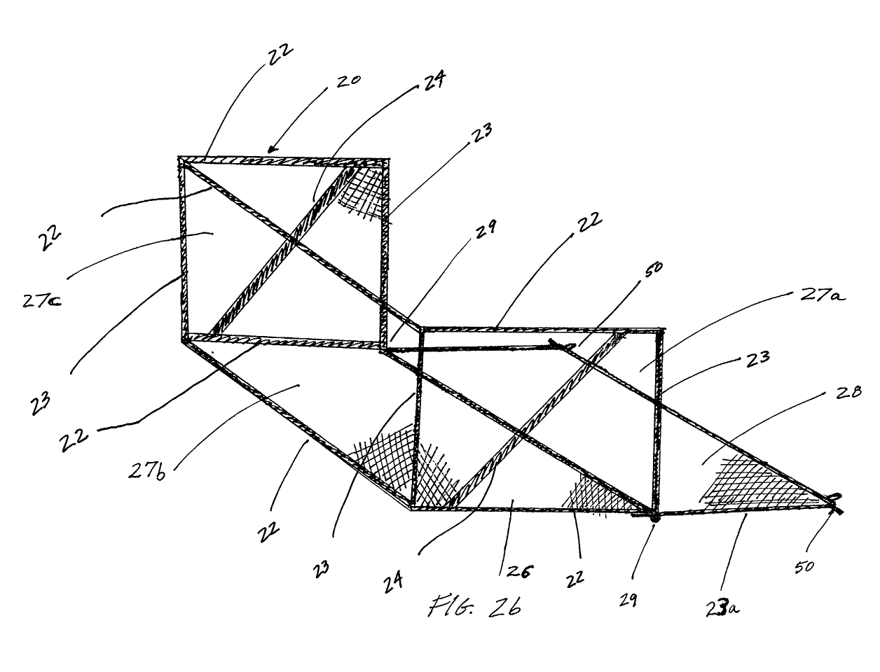

Referring to FIG. 2a, a side view of utility rack 20 of the present invention is depicted. Utility rack 20 is constructed generally of frame 21, which is comprised of horizontal frame components 22, vertical frame components 23 and diagonal frame components 24. Although any number of materials can be used to construct frame 21, in the preferred embodiment the various components of said frame are constructed of aluminum or other metal and are coated or painted to resist the elements. Said frame components are rigid, and can be in the shape of tubes, angle irons, solid bars or the like. Grating 25 is attached to horizontal frame components 22, vertical frame components 23, and diagonal frame components 24. Said grating 25 spans the gaps between the various components of frame 21 to further define the structure of utility rack 20. Vertical support component 23a forms one side of lift gate 28. Support component 23a, which is situated near the forward extent of said utility rack 20, is attached to hinge 29, which permits lift gate 28 to swing upward and downward. Latch mechanism 50 is provided near the top of vertical support 23a, to permit lift gate 28 to lock in an upright position, and to avoid unintended opening.

As can be seen from FIG. 2b, utility rack 20 is generally formed by base 26, and vertical wall sections 27a, 27b and 27c. Utility rack 20 is comprised of horizontal frame components 22, vertical frame components 23, and diagonal frame components 24. Lift gate 28 is swingably attached to utility rack 20 by hinges 29. Latch mechanisms 50 are located at the opposite extent of lift gate 28 from hinges 29. Grating 25 is attached to horizontal frame components 22, vertical frame components 23, and diagonal frame components 24, thereby helping to define base 26, vertical walls 27a, 27b and 27c, as well as lift gate 28. Lift gate 28 is swingably connected to utility rack 20 by hinges 29.

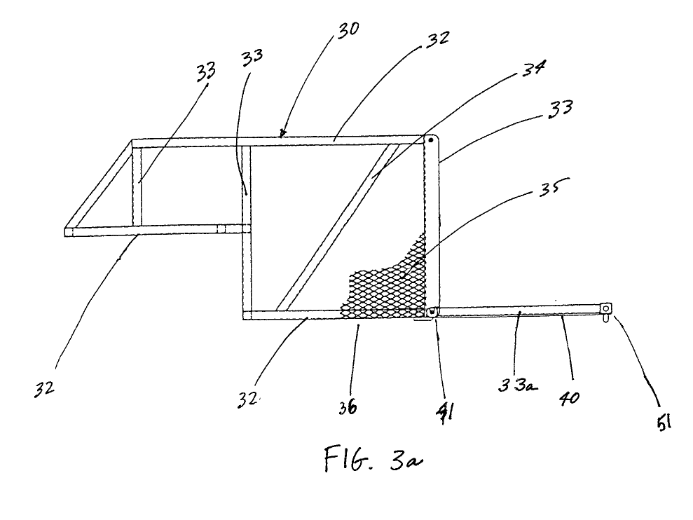

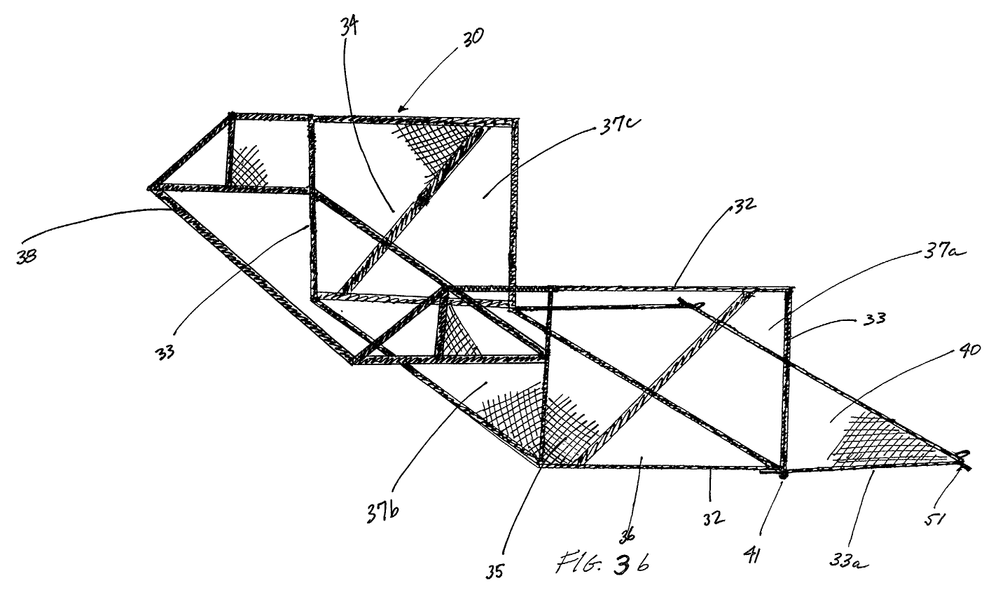

Referring to FIG. 3a, a side view of utility rack 30 of the present invention is depicted. Utility rack 30, which is designed to be installed at or near the rear of an ATV, is constructed generally of frame 31, which is comprised of horizontal frame components 32, vertical frame components 33, and diagonal frame components 34. Grating 35 is attached to said frame components to further define the structure of utility rack 30. Support component 33a forms one side of lift gate 40. Support component 33a, which is situated near the rear extent of said utility rack 30, is attached to hinge 41, which permits support component 33a, and thus lift gate 40, to swing upward and downward. Hinge 41 is located at the base of lift gate 40, while latch mechanism 51 is located near the opposite end of lift gate 40.

FIG. 3b depicts a top perspective view of utility rack 30 of the present invention. Utility rack 30 is generally formed by base 36, vertical wall sections 37a, 37b and 37c, as well as lift gate 40. Lift gate 40 is swingably connected to utility rack 30 via hinges 41. Grating 35 is attached to horizontal frame components 32, vertical frame components 33, and diagonal frame components 34, as well as lift gate 40. Vertical frame components 33 and horizontal frame components 32 form mounting extension 38. Although the exact configuration and size of mounting extension 38 can vary, said mounting extension provides a means for attaching utility rack 30 to the rear of an ATV.

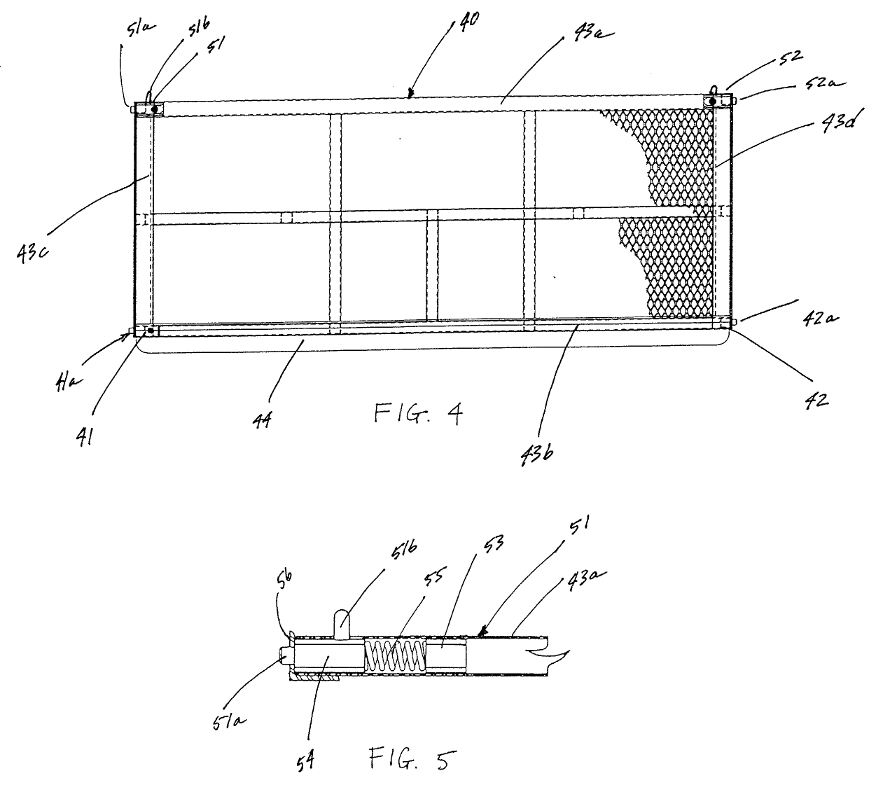

Referring to FIG. 4, lift gate 40, which is situated near the rear extent of said rear utility rack 30, has hinges 41 and 42, which permits lift gate 40 to hinge downward. Latch mechanisms 51 and 52 are provided near the top of lift gate 40, to permit lift gate 40 to lock in an upright position and avoid unintended opening or swinging. In the preferred embodiment, lift gate 40 can be detached and completely removed from utility rack 30, as desired.

Referring to FIG. 4, lift gate 40 is depicted as being detached from rear utility rack 30. Lift gate 40 has generally rectangular frame, comprised of horizontal members 43a and 43b, and vertical members 43c and 43d. Rigid flap section 44 extends downward from the base of horizontal member 43b. In the preferred embodiment, hinges 41 and 42 are located at the outer extent of horizontal member 43b. Said hinges 41 and 42 include outwardly facing extensions 41a and 42a, respectively, which are pivotally received within aligned holes in the internal surface of vertical frame components 33. In the preferred embodiment, extension 41a of hinge 41 is fixed, while extension 42a of hinge 42 is retractable to facilitate removal of the entire lift gate 40 from rear utility rack 30. Latch mechanisms 51 and 52 are situated near the upper extent of lift gate 40, and extend outward from horizontal member 43a. In the preferred embodiment, latch mechanisms 51 and 52 utilize rigid extensions 51a and 52a, respectively, which can be received within aligned holes on the inner face of vertical support components 33 of utility rack 30.

FIG. 5 depicts a side cross-sectional view of a lift gate latch mechanism 51 of the present invention. In the preferred embodiment, the structure of lift gate latch mechanism 51 is roughly identical to that of latch mechanism 52, as well as retractable hinge 42 at the base of lift gate 40. Furthermore, in the preferred embodiment, horizontal frame component 43a is hollow, and stop block 53 is fixedly mounted within horizontal frame component 43a, while sliding block 54 having rigid extension 51a and handle piece 51b is free to move laterally within horizontal frame component 43a. Compression spring 55, which is located between fixed stop block 53 and sliding block 54, biases sliding block 54 against retention plate 56. Retention plate 56 has a hole therethrough which is sized to receive rigid extension 51a. Accordingly, when sliding block 54 is biased against retention plate 56, rigid extension 51a extends outward beyond retention plate 56.

Although preferred embodiments of the subject invention have been described herein, it should be understood that various changes, adaptations and modifications may be made therein without departing from the spirit of the invention and the scope of the appended claims.

What is claimed is:

1. A utility rack for an all terrain vehicle comprising:
a. A roughly planar horizontal base;
b. A plurality of roughly planar vertical wall panels extending upward from said base,
c. A roughly planar vertical lift gate; and
d. A hinge at the bottom of said lift gate, swingably connecting said lift gate to two of said roughly planar vertical wall panels.

2. The utility rack of claim 1, wherein at least two of said roughly planar vertical wall panels are oriented parallel to one another.

3. The utility rack of claim 2, wherein said hinge comprises:
a. A first hole in one of said parallel wall panels;
b. A second hole in the other of said parallel wall panels, where said first and second holes face one another and are in vertical alignment with one another;
c. A first rigid extension positioned along one side of said lift gate, and rotatably disposed within said first hole; and
d. A second rigid extension positioned along the other side of said lift gate and rotatably disposed within said second hole.

4. The utility rack of claim 3, further comprising means for retracting said first rigid extension.

5. The utility rack of claim 4, wherein said means for retracting said first rigid extension comprises:
a. A fixed stop block;
b. A slidably disposed traveling block having said rigid extension attached thereto;
c. A retention plate having a hole for receiving said rigid extension;
d. A compression spring positioned between said fixed stop block and said traveling block, wherein said compression spring biases said traveling block against said retention plate.

6. The utility rack of claim 1, further comprising a latch mechanism near the top of the lift gate.
